(19) United States
(12) Patent Application Publication
(10) Pub. No.: US 2009/0255412 A1
(43) Pub. Date: Oct. 15, 2009

(54) Circulating filtration type frying machine

(76) Inventor: Young-Joo Song, Koyang-City (KR)

Correspondence Address: GEORGE LAWRENCE BOLLER, SUITE 316, 17199 N LAUREL PARK DR, LIVONIA, MI, 48152, US

(21) Appl. No.: 12/082,557

(22) Filed: Apr. 11, 2008

(51) Int. Cl. A47J 37/12

(52) U.S. Cl. 99/408

(57) ABSTRACT

Disclosed herein is a circulating filtration type frying machine, which heats oil in a vessel using heating means, such as a heater or a burner, to fry food. The frying machine includes a partition, which is provided in the vessel to partition a space in the vessel into a heating space and a frying space and comprises a horizontal part and a vertical part. An oil inlet is defined between the bottom of the vessel and the end of the horizontal part of the partition. An oil outlet is defined between a sidewall of the vessel and the upper end of the vertical part. The frying machine includes a collection space, which extends downwards from the frying space at a position adjacent to the oil inlet to collect residue of fried food therein. A valve is provided in the collection space to control discharge of the collected residue of the fried food. Thus, oil heated in the heating space is discharged through the oil outlet and is moved into the frying space. When the oil, which is moved into the frying space, fries the food and is moved into the oil inlet, the residue of the fried food contained in the oil can be collected in the collection space more effectively.

### BACKGROUND OF THE INVENTION

1. Field of the Invention

The present invention relates generally to circulating filtration type frying machines and, more particularly, to a circulating filtration type frying machine which is constructed such that, when oil heated by a heating means fries food and circulates, residue of fried food can be effectively collected.

2. Description of the Related Art

As in well known to those skilled in the art, a frying machine heats oil, which is charged in a vessel, using heat generated from a heater, which is installed in the vessel, or from a burner, which is provided below the bottom of the vessel, and fries food using the heated oil. In this process of frying food, residue is generated from the food or from frying powder applied to the food. The residue falls onto the bottom of the vessel which directly contacts the heater or flames of the burner, and it is oxidized by heat, thus contaminating the oil in the vessel.

In an effort to overcome the above problem, a “FRYING MACHINE” was proposed in Korean Utility Model Registration No. 382137. This frying machine is constructed such that the bottom of a vessel is inclined at a predetermined angle so that residue of fried food is collected in the area near the lower end of the inclined bottom to prevent the residue from directly contacting the flames of a burner. However, the conventional frying machine is problematic in that, when the flames of the burner contact the bottom of the vessel and heat oil charged in the vessel, heated oil is moved upwards by convection and moves the collected residue of fried food upwards, with the result that the residue is brought into contact with the heated oil and is thus oxidized.

Furthermore, as an apparatus for collecting and removing residue of fried food to prevent the oxidization of oil, a forced circulation frying machine, in which a connection pipe is coupled to a frying vessel and an oil circulating motor and a residue collection casing are coupled to the connection pipe, was proposed. However, because the forced circulation frying machine requires separate devices, such as the connection pipe, the motor and the residue casing, there are disadvantages in that the structure thereof is complicated, it is relatively expensive, and it is difficult to apply the structure to a small frying machine.

### SUMMARY OF THE INVENTION

Accordingly, the present invention has been made keeping in mind the above problems occurring in the prior art, and an object of the present invention is to provide a circulating filtration type frying machine, in which the space in a vessel is partitioned into a heating space for heating oil and a frying space for frying food, and which is constructed such that, when oil, which is heated in the heating space by a heating means, moves into the frying space to fry food and circulates in the vessel, the residue of fried food can be collected more effectively.

In order to accomplish the above object, the present invention provides a circulating filtration type frying machine for heating oil, charged in a vessel, using heating means to fry a food, the circulating filtration type frying machine including: a partition provided in the vessel to partition a space in the vessel into a heating space and a frying space, the partition comprising a horizontal part and a vertical part, with an oil inlet defined below the horizontal part, and an oil outlet defined around an upper end of the vertical part; and a collection space extending downwards from the frying space at a position adjacent to the oil inlet of the partition to collect residue of fried food, with a valve provided in the collection space to control discharge of the collected residue of the fried food, so that oil heated in the heating space is discharged through the oil outlet and is moved into the frying space, and, when the oil, which is moved into the frying space, fries the food and is moved into the oil inlet, the residue of the fried food contained in the oil is dropped into and collected in the collection space.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a circulating filtration type frying machine, according to an embodiment of the present invention;

FIG. 2 is a sectional view of the circulating filtration type frying machine of FIG. 1; and

FIG. 3 is a sectional view illustrating a circulating filtration type frying machine, according to another embodiment of the present invention.

### DESCRIPTION OF THE PREFERRED EMBODIMENTS

Hereinafter, preferred embodiments of the present invention will be described in detail with reference to the attached drawings.

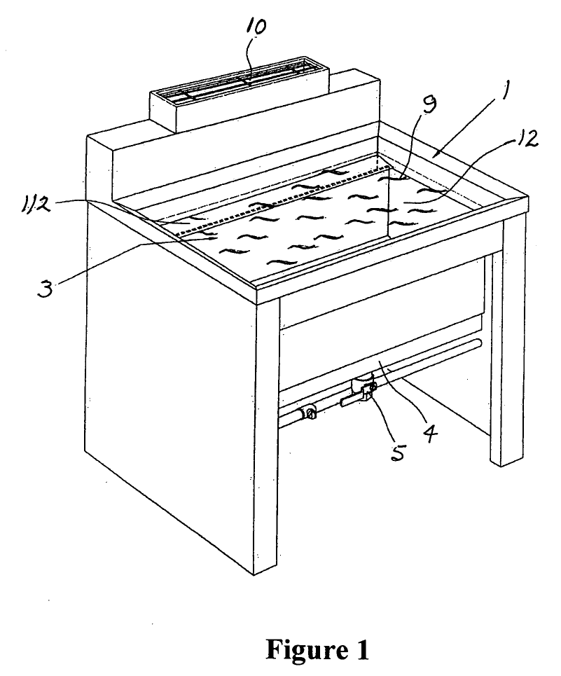

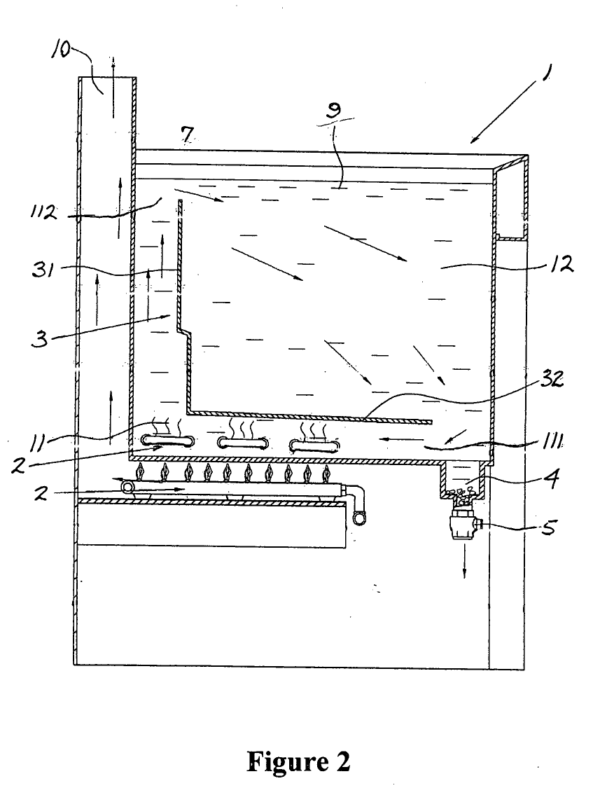

FIGS. 1 and 2 are a perspective view and a sectional view illustrating a circulating filtration type frying machine according to an embodiment of the present invention. In the drawings, reference numeral 1 denotes a vessel, 2 denotes a heating means comprising a heater or burner, 3 denotes a partition, 4 denotes a collection space, 5 denotes a valve, 6 denotes a first net, 7 denotes a guide plate, 8 denotes a second net, and 9 denotes oil.

In the circulating filtration type frying machine of the present invention, the heating means 2 using the heater or burner is installed in the vessel 1 or below the bottom of the vessel 1, which has a cylindrical or rectangular casing shape which is open on the upper end thereof, so that the heating means 2 directly or indirectly heats oil 9 that is charged in the vessel 1. The heater used as the heating means 2 uses electricity, and the burner used as the heating means 2 heats the oil 9 using flames generated by burning gas. In the case of the heating means 2 using the burner, flames generated by burning gas contact the bottom of the vessel 1 and thus primarily heat the oil 9, and exhaust heat thereof contacts the sidewalls of the vessel 1 until it is exhausted outside through an exhaust port 10, and thus maintains the temperature of the heated oil 9 such that the heated oil 9 can flow upwards more smoothly.

The vessel 1 partitions the space therein into a heating space 11 and a frying space 12 such that the oil 9 heated by the heating means 2 can circulate in the vessel 1.

In detail, partitioning the space in the vessel 1 into the heating space 11 and the frying space 12 is realized by installation of the partition 3, which is a metal bent plate. In the structure in which the partition 3 partitions the space in the vessel 1 into the heating space 11 and the frying space 12, an oil inlet 111, into which oil 9 is drawn into the heating space 11, is defined between the partition 3 for defining the heating space 11 and a portion of the bottom of the vessel 1. Furthermore, in the partition 3, a vertical part 31 extends from a horizontal part 32 such that oil 9, heated by the heating means 2, can be moved upwards by convection along the space defined between the vertical part 31 and the sidewall of the vessel 1. An oil outlet 112 is defined on the upper end of the vertical part 31. The volume of the heating space 11, which is defined by the partition 3, is approximately ⅓ to ½ of the volume of the frying space 12. Thus, oil 9 can be rapidly heated, and a circulation process, in which the heated oil 9 flows upwards along the vertical part 31, moves into the frying space 12, and moves into the oil inlet 111 again, can be smoothly implemented.

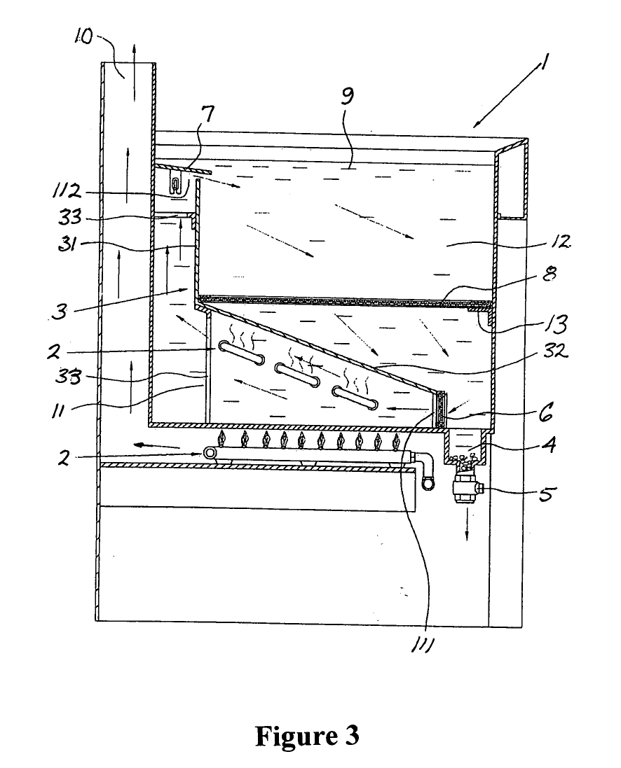

Meanwhile, as another embodiment of the circulating filtration type frying machine of the present invention, as shown in FIG. 3, a horizontal part 32 of a partition 3 is inclined downwards from a vertical part 31 towards an oil inlet 111, such that oil 9, which is in a heating space 11 and is heated by a heating means 2, can be smoothly moved upwards. The inclined part (horizontal part) 32 of the partition also serves to effectively collect residue of fried food using the inclination thereof.

Furthermore, the installation of the partition 3 is not limited to a method in which it is fixed to the vessel 1 by welding. As shown in FIG. 3, the partition 3 may be removably coupled to a vertical or horizontal support 33, which is provided in the vessel 1 to maintain a predetermined distance between the partition 3 and the inner surface of the vessel 1, thus allowing easy clean-up.

The collection space 4 for collecting residue of fried food extends downwards from the frying space 12 around the oil inlet 111 of the partition 3. The collection space 4 is an unheated space, thus preventing the collected residue of fried food from being oxidized. In addition, the valve 5 is provided in the collection space 4 to enable a user to exhaust the collected residue of fried food from the collection space 4 when necessary.

Furthermore, as in the embodiment shown in FIG. 3, the first net 6 may be removably provided on the oil inlet 111 of the partition 3 to prevent the residue of fried food from being drawn into the heating space. The guide plate 7 may be provided above the oil outlet 112 of the partition 3 to prevent food from being undesirably drawn into the oil outlet 112 while frying the food and to guide heated oil 9, which is discharged from the oil outlet 112, into the frying space 12. The second net 8, a first end of which contacts the upper end of the inclined part 32, and a second end of which is placed on a bracket 13, mounted to the inner surface of the sidewall of the vessel 1, may be horizontally provided at a predetermined position in an approximately central portion of the frying space 12, thus preventing relatively large pieces of fried food residue from falling towards the oil inlet 11 of the heating space 11 or the collection space 4.

The operation of the circulating filtration type frying machine of the present invention having the above-mentioned construction will be explained herein below.

First, oil 9 is charged into the vessel 1 to a position higher than the upper end of the oil outlet 112 of the heating space 11. Thereafter, the heating means 2 using the heater or burner is turned on to generate heat. Then, heat is transmitted to oil 9 in the heating space 11, so that the oil 9 in the heating space 11 is first heated before the oil 9 in the frying space 12 is heated. The oil 9, which is heated in the heating space 11, is moved upwards by convection, is discharged through the oil outlet 112, and is moved into the frying space 12.

The oil 9, which is moved into the frying space 12, fries food. The oil 9, which transmits heat to the food, is continuously moved towards the lower portion of the frying space 12 by the continuous flow of the heated oil 9. The oil 9, which is moved to the lower portion of the frying space 12, is supplied into the inlet 111, which is defined by the partition 3, and is heated again by heat transmitted from the heating means 2, thus being moved upwards. This circulation of oil 9 is repeated. Here, when oil 9, which circulates in the vessel 1, is moved towards the oil inlet 111, residue of fried food which has been contained in the oil 9 is dropped into and collected in the non-heating collection space 4.

Because the non-heating collection space 4 is spaced apart from the heating means 2 by a predetermined distance, the residue of fried food which is collected in the non-heating collection space 4 is prevented from being oxidized, thus preventing the oil 9 from being contaminated. The residue of fried food which is collected in the non-heating collection space 4 can be exhausted by controlling the valve 5 when necessary.

Furthermore, in the case where the first net 6 is provided on the oil inlet 111 of the partition 3, residue of fried food can be effectively prevented from being drawn into the heating space 11. In the case where the guide plate 7 is installed above the oil outlet 112 of the partition 3, food can be prevented from being drawn into the heating space 11 when frying the food, and heated oil 9, which is discharged through the oil outlet 112, can be stably guided into the frying space 12.

Moreover, in the case where the second net 8 is horizontally provided in an approximately central portion of the frying space 12 such that the first end of the second net 8 contacts the upper end of the inclined part 32 and the second end thereof is placed on the bracket 13, mounted to the inner surface of the sidewall of the vessel 1, food to be fried can be prevented from undesirably falling towards the oil inlet 111 of the heating space 11 or the collection space 4. In addition, the second net 8 serves to section the oil 9 in the frying space 12 into oil 9, which is heating the food, from oil 9, which has been already used to heat the food, thus making it possible to fry the food more effectively.

Although the preferred embodiments of the present invention have been disclosed for illustrative purposes, the present invention is not limited to the embodiments.

Furthermore, those skilled in the art will appreciate that various modifications, additions and substitutions are possible, without departing from the scope and spirit of the invention as disclosed in the accompanying claims. Therefore, these modifications, additions and substitutions must be considered to fall within the bounds of the present invention.

As described above, in a circulating filtration type frying machine according to the present invention, a space in a vessel is partitioned into a heating space for heating oil and a frying space for frying food by a partition installed in the vessel. Oil in the heating space is heated by a heating means, and the heated oil moves into the frying space to fry food and is moved into the heating space again. During this circulation process, residue of fried food is effectively collected into a non-heating collection space, thus preventing the oxidization of oil.

What is claimed is:

1. A circulating filtration type frying machine for heating oil, charged in a vessel, using heating means to fry a food, the circulating filtration type frying machine comprising:
a partition provided in the vessel to partition a space in the vessel into a heating space and a frying space, the partition comprising a horizontal part and a vertical part, with an oil inlet defined below the horizontal part, and an oil outlet defined around an upper end of the vertical part; and
a collection space extending downwards from the frying space at a position adjacent to the oil inlet of the partition to collect residue of fried food, with a valve provided in the collection space to control discharge of the collected residue of the fried food, so that
oil heated in the heating space is discharged through the oil outlet and is moved into the frying space, and, when the oil, which is moved into the frying space, fries the food and is moved into the oil inlet, the residue of the fried food contained in the oil is dropped into and collected in the collection space.

2. The circulating filtration type frying machine as set forth in claim 1, wherein the horizontal part of the partition is inclined at a predetermined angle, so that the heated oil is smoothly moved upwards and the residue of the fried food is smoothly moved downwards.

3. The circulating filtration type frying machine as set forth in claim 1, further comprising:
a first net provided on the oil inlet of the heating space to be removable to prevent the residue of the fried food from being drawn into the heating space;
a guide plate provided above the oil outlet of the partition to prevent the fried food from being drawn into the hating space through the oil outlet and to guide the heated oil, which is discharged from the oil outlet, into the frying space; and
a second net provided in a central portion of the frying space and oriented in a horizontal direction to prevent the fried food from falling towards the oil inlet of the heating space or the collection space, the second net being placed on the partition and a bracket, which is attached to a second sidewall of the vessel.
